(19) United States
(12) Patent Application Publication
(10) Pub. No.: US 2003/0058196 A1
(43) Pub. Date: Mar. 27, 2003

(54) Method for reducing power consumption in field emission display devices by efficiently controlling column driver output voltage

(76) Inventors: Ronald L. Hansen, San Jose, CA (US); Jay Friedman, Felton, CA (US)

Correspondence Address: WAGNER, MURABITO & HAO LLP, Third Floor, Two North Market Street, San Jose, CA, 95113, US

(21) Appl. No.: 09/965,367

(22) Filed: Sep. 26, 2001

(51) Int. Cl. G09G 3/22

(52) U.S. Cl. 345/75.2

(57) ABSTRACT

The present invention provides a method and circuit to efficiently change a present column voltage output level to a desired next column voltage output level using digital control circuitry. In one embodiment, the present column voltage output level at an intersection of an active row line and a column line is stored. In substantially the same time, a desired next column voltage level is received for the next row data line of the same column line. The difference between the present column voltage and the desired next voltage is determined and digitized. The digitized voltage difference is translated to a clock time necessary to apply a high current to column driver to attain the desired next column voltage level. The circuit providing high current is active only for the clock time. In this way, bias current and power dissipation are maintained at a low level during quiescent conditions. A quiescent current is continuously applied to all pixels for maintaining their gray cale levels thus compensating for leakage current.

### FIELD OF THE INVENTION

The present invention pertains to the field of flat panel display screens. More specifically, the present invention relates to the field of flat panel field emission display devices (FEDs).

### BACKGROUND OF INVENTION

Flat panel field emission displays (FEDs), like standard cathode ray tube (CRT) displays, generate light by impinging high-energy electrons on a picture element (pixel) of a phosphor screen. The excited phosphor then converts the electron energy into visible light. However, unlike conventional CRT displays which use a single electron beam, or in some cases three electron beams, to scan across the phosphor screen in a raster pattern, FEDs use stationary electron emitters for each color element of each pixel. This allows the distance from the electron source to the display screen to be very small compared to the distance required for the scanning electron beams of the conventional CRTs. Furthermore, FEDs consume far less power than CRTs. These factors make FEDs ideal for portable electronic products such as laptop computers, pocket-TVs, personal digital assistants and portable electronic games.

As mentioned, FEDs and conventional CRT displays differ in the way the image is created. Conventional CRT displays generate images by scanning an electron beam across the phosphor screen in a raster pattern. During the raster scan, an electron beam scans along the row (horizontal) direction, and its intensity is adjusted according to the desired brightness of each pixel of the row. After a row of pixels is scanned, the electron beam steps down a row and scans the next row with its intensity modulated according to the desired brightness of that row. In contrast, FEDs generate images according to a “matrix” addressing scheme that does not involve scanning a single beam across the screen. Each electron beam of the FED is formed at the intersection of individual rows and columns of the display. Rows are updated sequentially. A single row electrode is activated alone with all the columns active, and the voltage applied to each column determines the strength of the electron beam formed at the intersection of that row and column. Then, the next row is subsequently activated and new brightness information is set again on each of the columns. When all the rows have been updated, a new frame is displayed.

Pixel brightness in a FED depends on the amount of voltage potential and the time of application of such voltage across the row electrode and the column electrode. The larger the voltage potential and longer the time of application of the voltage, the brighter the pixel.

During the operation, all columns are driven with gray-scale data and simultaneously one row is activated at a time. The gray-scale information causes the column drivers to assert different voltage amplitudes (amplitude modulation) to realize the different gray-scale contents of the pixel. This causes a row of pixels to illuminate with the proper gray scale data, such an illumination of pixels is possible in accordance with teaching of U.S. Pat. No. 6,147,655 issued Nov. 14, 2000 entitled “COLUMN DRIVER OUTPUT AMPLIFIER WITH LOW QUIESCENT POWER CONSUMPTION FOR FIELD EMISSION DISPLAY DEVICES” filed on Sep. 29, 1998 which is incorporated by reference herrein. This is then repeated for another row, etc., until the frame is filled.

Capacitive nature of pixels requires application of current when changed from one voltage level to another voltage level is desired. Furthermore, it is appreciated that an entire frame, in a FED, is refreshed 60 times per second, therefore every row line needs to be sequentially driven once over the course of 1/60^{th} of a second. For example, in a FED with 240 rows, a particular row is turned on for approximately 65μ seconds. Thus, the time available for imparting new gray scale information into a pixel is a fraction of that 65μ second.

Considering the type of capacitance found in the pixels, and relatively short time available to charge these capacitances, a peak current of 10-50 milliamperes may be required to change the gray scale value from row to row. However, it is appreciated that once changed, maintenance of the desired voltage level requires only a small supply of current, at the level of a μ amps or less.

To respond to such requirements stated, the column driver output must have a very large dynamic current supply range (e.g., 10-50 mil amps to 1/10-1/100 of μ amps). Typical output transistors do not have such an operational dynamic range.

To accommodate such a wide output current range the conventional practice is to use two separate analog circuit drivers for supplying current from a column driver. A first driver supplies high current for charging and discharging (to establish the gray scale value) and a second low current transistor is dedicated to the quiescent voltage level to maintain the gray scale value. The problem with the traditional practice is to know when to turn the high current transistor on and when to turn it off and allowing low current to sustain the quiescent level. When the high current transistor is not completely turned off the internal quiescent current of high current transistor is in hundreds of μA per column (e.g., approximately 600 μA per output for an SVGA-size driver). For a 240 output driver with a 15 V operating range, approximately 2 W power is dissipated per driver. It is desirable to reduce such dissipation of power.

Traditionally analog sensing devices are used to govern the high current driver. An analog sensor repeatedly or continuously compares the column voltage output level with the desired voltage level until the desired voltage level is achieved. The high current transistor will be turned off when the target voltage is reached. Unfortunately, analog driver circuitry with related sensor circuits consume a large amount of power, substrate area and are complex to design.

Conventional Art FIG. 1 depicts a typical analog column driver 100. Analog signal comparator 120 compares voltage output level 101 from the column driver with the voltage required 102 by a target pixel at currently active row. Analog signal comparator 120 compares the two voltage signals and sends the resulting voltage difference signal 130 to analog control and driver circuit 140. Analog control circuit 140 will turn its embedded high current transistor off when signal 130 is substantially equal to zero.

Analog sensor circuits satisfy the requirements for controlling the column voltage, however analog sensor circuits and driver circuits require substantial substrate space in an integrated circuit where space is at premium. Generally, in design of an IC efforts are made to eliminate unnecessary use of substrate space. Furthermore, the analog approach consumes a relatively large amount of power.

Therefore, what is needed is a method to provide voltage to a column line of a pixel, which meets the gray scale requirements of that particular pixel and prevents excessive power dissipation. What is further needed is to employ a method, which minimizes substrate space.

### SUMMARY OF THE INVENTION

Accordingly, an embodiment of the present invention provides a method enabling a column driver to supply a desired output voltage level based on a predetermined clock time using digital drive circuitry rather than an analog sensing circuit. A high current transistor is dedicated to rapidly supply high current necessary to reach the gray scale level required by a pixel. The voltage level of the present row is known for a given pixel and so is the next voltage level for the next row. These values are converted into a digital timing value which is used to time the high current driver during its duty cycle. The high current transistor is then turned off. Furthermore, an embodiment of the present invention eliminates the use of an analog sensing device, which results in saving silicon space on an integrated circuit. Finally, a low current transistor continuously provides quiescent current to compensate for voltage leakage on pixels across a row after the desired gray scale levels have been established.

These and other objects and advantages of the present invention will no doubt become obvious to those of ordinary skill in the art after having read the following detailed description of the preferred embodiment which are illustrated in the various drawing figures.

The present invention provides a method to efficiently change a present column voltage output level to a desired next column voltage output level. In one embodiment of the present invention, the present column voltage output level at an intersection of an active row line and a column line is stored as a digital value in the column data. In substantially the same time, a desired next digital column voltage level is received for the next row data line. The difference between the present column voltage level and the desired next voltage level is determined and digitized. The digitized voltage difference is then translated to a clock time necessary to apply a high current driver to attain the desired next column voltage level on the column line. Significantly, the circuit providing high current is inactive after the expiration of the clock time. At the expiration of the clock time, the present voltage level and the desired next voltage level are equal. In this way, bias current and power dissipation are maintained at a low level during quiescent conditions. The quiescent current is continuously applied to all pixels for maintaining their quiescent voltage level thus compensating for leakage in pixels across the row line.

More specifically, the present invention discloses a method and a circuit for enabling a first row line of a matrix display device wherein the first row line includes a plurality of pixels. The voltage value of a first pixel disposed at an intersection of the first row line and a first column line is stored in column driver memory. Then, the voltage value of a second pixel disposed at an intersection of the next row line in sequence and the first column line is obtained and compared with the stored voltage value of the first pixel. The voltage difference between the first voltage value and the second voltage value is calculated and digitized. The digitized voltage difference is translated into a clock time, where the clock time is time necessary to apply high current to the column driver (of the first column line) to attain the required output voltage on the first column line. The high current transistor applies high current to the column driver and shuts off when the time expires such that the column driver reaches the required voltage value for the next row.

A combiner circuit combines the output of the high current driver with a quiescent current driver which remains enabled at all times to maintain gray scale level in the face of leakage current.

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 depicts the conventional control of current supply to a column driver using analog sensor and control circuits.

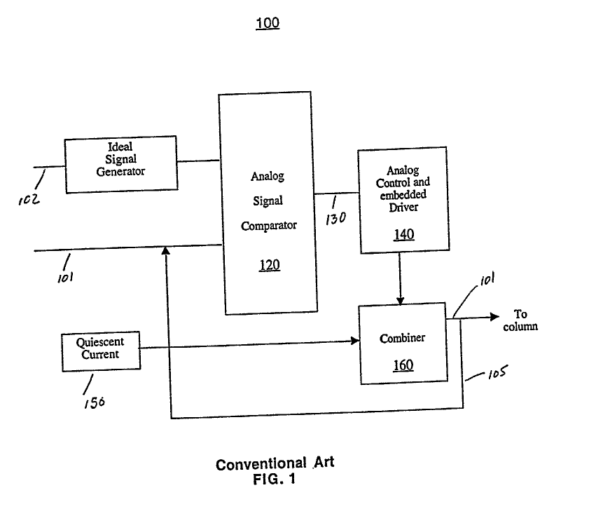

FIG. 2 is a plan view of internal portion of the flat panel FED screen of the present invention and illustrates several intersecting rows and columns of the display.

FIG. 3 illustrates a plan view of a flat panel FED screen in accordance with the present invention illustrating row and column drivers and numerous intersecting rows and columns.

FIG. 4 is a schematic representation of a plurality of rows and column intersections where column voltage requirements substantially differ from one row to the next.

FIG. 5 is a block diagram of an embodiment of the present invention illustrating a digitized voltage difference translated to a digital time period required for providing a required column voltage output.

FIG. 6 is a flowchart of the steps in a process of determining the time required to apply high current to a target pixel for establishing its gray scale using a column driver having a digital control mechanism.

### DETAILED DESCRIPTION OF THE PREFERRED EMBODIMENTS

Reference will now be made in detail to the preferred embodiments of the present invention, a method for reducing power consumption in field emission display devices by efficiently controlling column driver output voltage, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

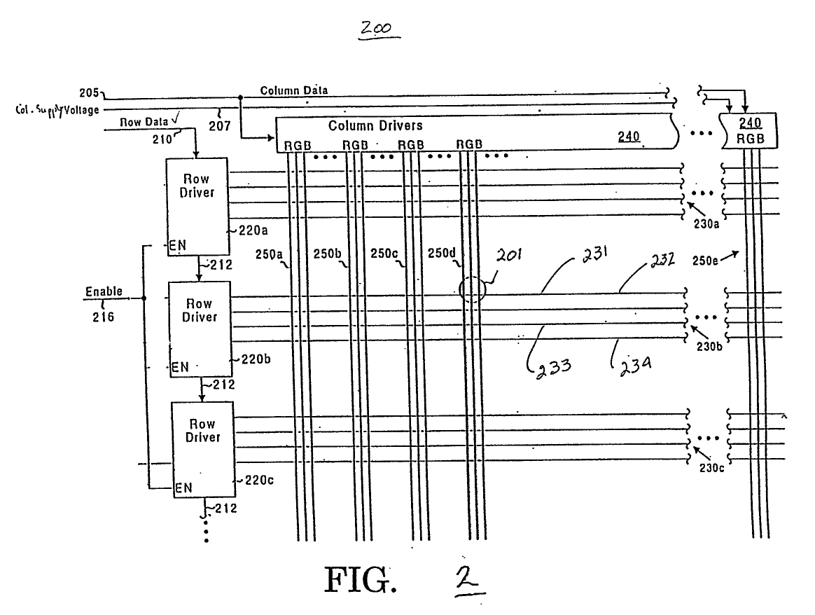

FIG. 2 illustrates a FED flat panel display 200 in accordance with an embodiment of the present invention. The FED flat panel display 200 consists of n row lines (horizontal) and m column lines (vertical). Shown in FIG. 2 are row groups 230a, 230b, and 230c which are driven by row driver circuits 220a, 220b and 220c respectively. In one embodiment of the present invention there are 240 rows which can be driven by multiple row driver circuits. However, it is appreciated that the present invention is applicable to FED flat panel displays with any number of row lines. Also FIG. 2 depicts column groups 250a, 250b, 250c and 250d. In one embodiment of the present invention there are 320 column lines. For a color pixel each pixel requires three columns (Red, Green, and Blue) for the total of 960 column lines for the same FED panel display. It is appreciated that the present invention is equally applicable for a FED flat panel display with any number of column lines. Column lines 250a-d are driven by column driver 240 and depending upon the design, any number of columns may be driven by a single column driver. A separate drive circuit within column driver 240 is provided for each separate column line.

Refreshing a FED flat panel display is a row by row process and performed one frame at a time. An enabling signal 216 activates one row of a FED flat panel display at a time while all columns are in an active state. Image data is divided into sections the size of a row line and are fed into column drivers via column data line 205. Row data 210 simply rotates a “1” through the row drivers such that only one row and driver is active at a time. In one embodiment of the present invention row 231 is turned on by enabler 216 while column line 250d is in an active state with gray scale data. Column line 250d receives gray scale information from an associated column driver and provides an output voltage to pixel 201, which is disposed at the intersection of the row line 231 and column line 250d. Next in sequence is row line 232 which will be activated and the same column driver then provides different gray scale information on the column line 250d. The new gray scale requirements call for different column voltage outputs. The process will continue row by row until the entire frame is represented and the display panel is refreshed within the display frame rate.

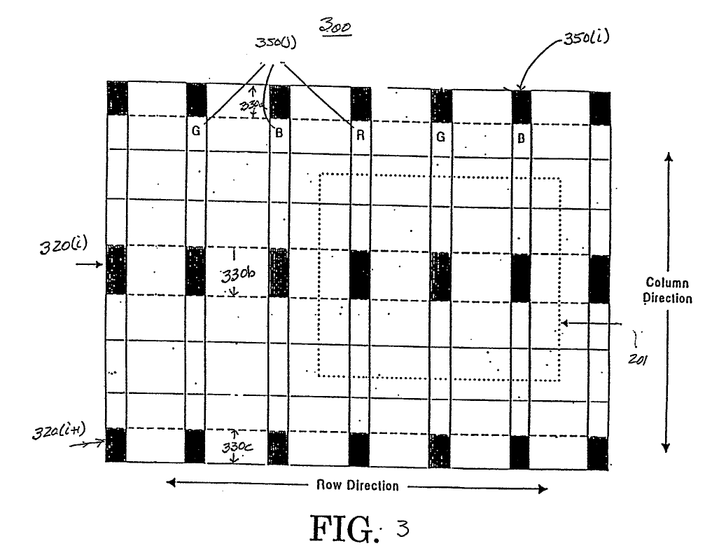

FIG. 3 illustrates a portion of a FED flat panel display 200 which is subdivided into an array of horizontally aligned rows and vertically aligned columns of pixels. FIG. 3, in particular, depicts pixel 201 of FIG. 2. Dashed lines indicate the boundaries of a respective pixel 201. Three separate row lines 330 are shown. Each row line 330 is a row electrode for one of the rows of pixels in the array. A pixel row is comprised of all of pixels along one row line 330.

Each column of pixels has three column lines 350: (1) one for red; (2) a second for green; and (3) a third for blue. This structure 300 is described more in detail in U.S. Pat. No. 5,477,105 issued on Dec. 19, 1995 to Curtin, et al., which is incorporated herein be reference. During the screen refresh cycle (performed at a rate of approximately 60 Hz in one embodiment), only one row 320(i) is enabled at a time and all column lines 350(j) are energized to illuminate the one row of pixels. This process is performed sequentially in time, row by row, until all pixel rows are illuminated to display the frame. The above FED configuration is described in more detail in the following United States Patents: U.S. Pat. No. 5,541,473 issued on Jul. 30, 1996 to Duboc, Jr. et al.; U.S. Pat. No. 5,559,389 issued on Sep. 24, 1996 to Spindt et al.; U.S. Pat. No. 5,564,959 issued on Oct. 15, 1996 to Spindt et al.; and U.S. Pat. No. 5,578,899 issued Nov. 26, 1996 to Haven et al., which are incorporated herein by reference.

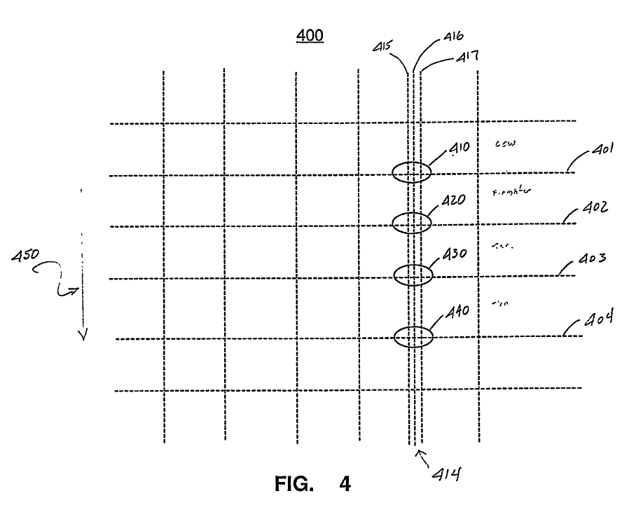

FIG. 4 is a schematic representation of a plurality of rows 401-404 and an exemplary column lines 414, 416, 417 (“414”) and pixels 410, 420, 430 and 440, which were generally depicted in FIG. 3. It is appreciated that each column line of 415-417 is coupled to a separate column driver that operates independently to provide red, green and blue data to the resulting pixels. In one embodiment of the present invention, each one of the pixels 410, 420, 430 and 440 has a different gray scale requirement. For example, pixel 410 may have to be illuminated with a low brightness and color, pixel 420 may have requirements for somewhat brighter color and illumination, while pixel 430 may require maximum brightness and color and pixel 440 is to have minimum color and brightness.

Furthermore, in this embodiment of the invention row lines 401-404 are turned on in sequence and in the direction 450. Row driver 220b of FIG. 2 enables row line 401 while column driver 240 turns column lines 414 and all other column lines to “on” position. Column driver 240 receives gray scale information for pixel 410, about the degree of illumination required by pixel 410, which in this example is low brightness, and will provide a voltage output sufficient to illuminate pixel 410 with low brightness. Next, row line 402 is enabled and pixel 420 has to be illuminated somewhat brighter. The column voltage drivers increase voltage potential to accommodate for the required brightness. Next, the pixel disposed at the intersection of row line 403 and the same column lines requires a higher voltage potential difference to cause a maximum brightness. Pixel 440 is to have minimum brightness. Column drivers 240 reduce column voltage output across column lines 414 such that pixel 440 is illuminated with minimum brightness.

It is appreciated from the discussion above that a column driver is required to present different gray scale voltage levels on its associated column line every row cycle. For a display of n rows, there are n row cycles for every frame update period. Therefore, the column drivers are switching voltage levels rapidly and frequently.

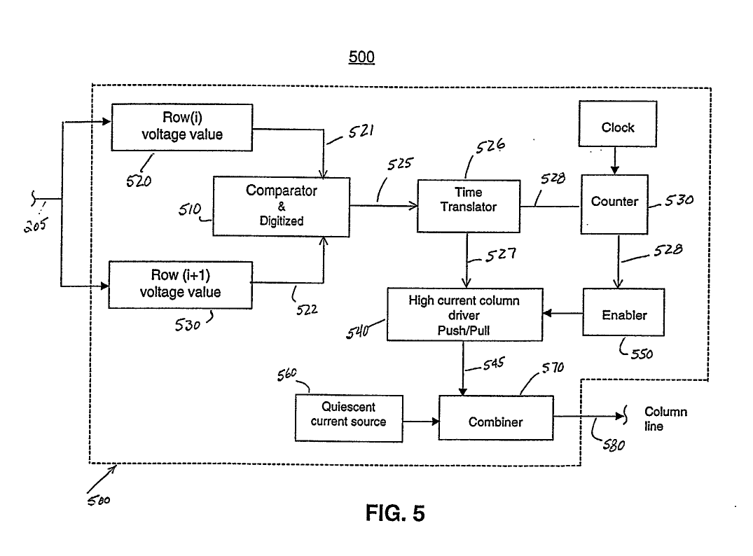

FIG. 5 depicts a block diagram 500 of an embodiment of the present invention which is a modified column driver that utilizes digital timing control for the high current driver. Comparator 510 receives voltage output of column line 350(i) of FIG. 3 at row line 320(i) of FIG. 3. This digital voltage value is obtained from the column data and is stored in memory 520 as the present voltage. Comparator 510, then receives voltage requirement of column line 350(i) at row 320(i+1) from memory 530. This also comes from the column data. This voltage value is the desired voltage output of column line 350(i) at row 320(i+1).

Comparator 510 compares the present voltage value stored in the memory and the desired voltage and determines the digital difference. Comparator 510 then digitizes the difference between the two voltages and sends the result via signal 525 to time translator device 526. Time translator device 526 translates signal 525 into a digital clock time period and a polarity sign. The clock time period or “count” is sent to counter 530 via signal 528 to reset and start counting and the polarity sign is sent to the high current column driver 540 via signal 527. Enabler 550 enables high current column driver 540 while the counter 530 is counting prior to reaching zero. High current column driver 540 is a push/pull transistor (not shown), which provides high current when signal 527 is positive and sinks current when signal 527 is negative. A combiner 570 combines the voltage of the high current driver 540 with the always enabled quiescent current source and outputs the result over the column driver 580 which, for discussion, is column drive 350(i).

In one embodiment of the present invention column line 415 of FIG. 4 is required to provide an output voltage to illuminate the red element of pixel 410, disposed at the intersection of column line 415 and row line 401, with low brightness. Considering capacitive nature of pixel 410, the high current transistor of high current column drive 540 of FIG. 5 supplies sufficient current to provide the required voltage to cause low brightness illumination in the red element of pixel 410.

Row line 402 is enabled next. Column data line 205 of FIG. 2 provides gray scale data to all pixels in row line 402 and accordingly pixel 420 has to be illuminated slightly brighter. Comparator 510 receives gray scale information of the red element of pixel 420 and compares the new voltage requirement with the voltage level provided to the red element of pixel 410. Because the red element of pixel 420 has to be slightly brighter, a higher voltage required, thus signal sign 527 is positive. High current column drive 540 provides high current via its high current transistor to column line 415 for the computed clock time 528. The high current transistor is turned off upon expiration of clock time 528.

The red element of pixel 440 has to be illuminated with a minimum brightness. The voltage value output at column 415 of pixel 430 was set for the maximum brightness. The voltage required to illuminate pixel 440 is less than the previous voltage because the brightness required is at minimum level. Comparator 540 has a negative value for the red voltage difference, thus the sign is negative, however there is a value by which the voltage applied to the red element of pixel 440 has to be lowered. Thus, signal sign 527 is negative but there is a clock time period for which the column line 415 has to discharge its output voltage. High current column driver will sink voltage of column line 415 for the computed clock time 528.

It is appreciated that when high current transistor 540 is turned off, the inherent quiescent current of high current transistor is also turned off. There is no quiescent current flow from the high current transistor when high current driver 540 is turned off and subsequently there is no power dissipation due to high current transistor in its off position.

Quiescent current source 560 of FIG. 5 is a low current transistor, which continuously provides current to all pixels and compensates for leakage current.

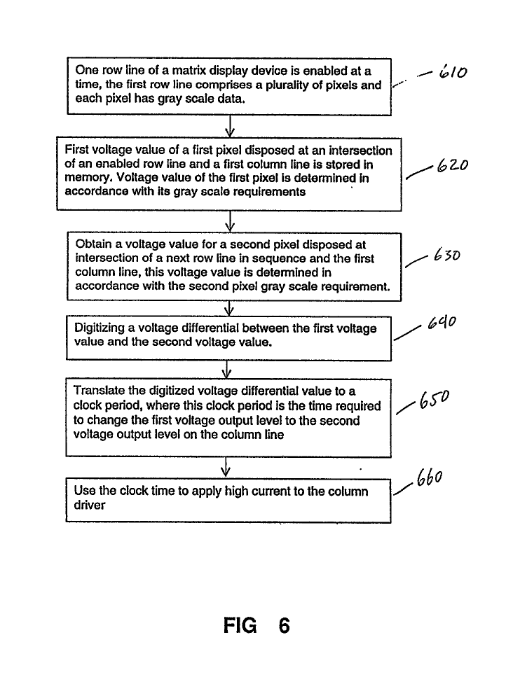

FIG. 6 is a flowchart of the steps in a process of determining the time required for applying high current to a target pixel.

In step 610 of FIG. 6, a first row line of a matrix display is enabled. The row line includes a plurality of pixels.

In step 620 of FIG. 6, a voltage value of a first pixel disposed at an intersection of the first row line and a first column line is stored in the column driver memory.

In step 630 of FIG. 6, a desired voltage required by next pixel in sequence disposed at the intersection of the next row line in sequence and the same column line is obtained.

In step 640 of FIG. 6, the difference between the first and the second voltage is determined and digitized.

In step 650 of FIG. 6, the digitized voltage difference is translated into clock time or count required for the high current transistor to charge the column line of the pixel to reach the desired voltage.

In step 660 of FIG. 6, the clock time of step 650 is used to charge the pixel. This is performed by counting the clock time and enabling the high current driver during the clock time only.

In summary, the present invention provides a method for supplying column voltage output to a plurality of pixels disposed at the intersection of the column line and a plurality of row lines. The method reduces unwanted power dissipation by a transistor providing current to the column driver. Furthermore, digitizing the voltage difference between the present voltage level and the next voltage level and translating the difference to clock time provides an efficient digital mechanism and method of illuminating a pixel while substantially reducing the silicon space required in the conventional method.

The foregoing description of specific embodiment of the present invention has been presented for purpose of illustration and description. They are not intended to be exhaustive or to limit the invention to the precise form disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for driving a column line in a matrix display device, said method comprising the steps of:
a. computing a digital voltage difference, wherein said digital voltage difference is between a column voltage output level on a column line at a first pixel and a column voltage output level on said column line at a second pixel;
b. translating said digital voltage difference into a clock time, wherein said clock time is that time required to attain said voltage output level at said second pixel from said voltage output level at said first pixel; and
c. enabling a high current driver coupled to said column line for said clock time and disabling said high current driver.

2. A method as described in claim 1 wherein said first pixel and said second pixel are disposed at the intersection of a first row line and said column line and a second row line and said column line.

3. A method as described in claim 2 wherein said first and said second row lines are sequential row lines.

4. A method as described in claim 2 where said first and said second row lines are adjacent.

5. A method as described in claim 1 where said matrix display comprises a plurality of row lines and a plurality of column lines.

6. A method as described in claim 1 where said row lines are driven by two row drivers.

7. A method as described in claim 1 where said rows are enabled sequentially.

8. A method as described in claim 7 where said first pixel is disposed at an intersection of an enabled row line and said column line and, wherein said second pixel is disposed at an intersection of a next row in sequence to be enabled and said column line.

9. A method as described in claim 1 further comprising the steps of providing quiescent current on said column line to compensate for leakage current.

10. A method for driving a column line in a matrix display device, said method comprising the steps of:
a. providing first and second drivers for applying current to said column line, wherein said first and said second drivers provide high current and low current to said column line respectively;
b. digitizing a difference in voltage requirements between a first pixel and a second pixel, wherein said first and said second pixels receive voltage from said column line; and
c. translating said digitized voltage difference into a clock count, wherein said clock count measures the time required to change a first voltage on said column line for said first pixel to a second voltage on said column line required by said second pixel.

11. A method as described in claim 10 wherein said second driver provides low current to said column line to compensate for leakage current.

12. A method as described in claim 10 wherein said matrix display comprises a plurality of row lines and a plurality of column lines.

13. A method as described in claim 10 wherein said first driver turns off at the expiration of said clock count.

14. A method as described in claim 12 wherein said first pixel and said second pixel are in adjacent rows.

15. A method as describe in claim 10 further comprising d. enabling a first driver during said clock count.

16. A method for driving a column fine in a matrix display where said matrix display device comprises a plurality of row lines and a plurality of column lines, said method comprising the steps of:
a. enabling one row line of said plurality of row lines at a time, wherein each row line comprises a plurality of pixels comprising gray scale data;
b. storing a voltage output level applied to a first pixel, wherein said first pixel is disposed at intersection of an enabled row line and a column line, wherein said voltage output level is determined in accordance with gray scale requirements of said first pixel;
c. obtaining a second voltage output level of a second pixel disposed at intersection of said column line and a row line next in sequence to be enabled, said second voltage output level being determined in accordance with gray scale requirements of said second pixel;
d. digitizing a voltage difference of said first and second voltages; and
e. translating said digitized voltage difference to a clock period, where said clock period is the time required to change said first voltage output level to said second voltage output level on said column line.

17. A method as describe in claim 16 further comprising enabling a first driver during said clock count.

18. A column driver circuit for a display device comprising:
a circuit for computing a digital difference between a first voltage applied on a column line for an nth row in a display matrix and a second voltage applied on said column line for an (n+1)th row;
a translator circuit for translating said digital difference into a timer count value;
an enabler circuit for generating an enable signal corresponding to said timer count value; and
a high current driver for generating and analog signal to be driven over said column line in response to said enable signal and for turning off when disabled.

19. A circuit as described in claim 18 further comprising:
a quiescent driver circuit for generating a quiescent current signal; and
a combiner circuit for combining said quiescent current signal with said analog voltage signal into a resultant output signal driven over said column line.

20. A circuit as described in claim 18 wherein said circuit for computing also generates a sign signal which is coupled to said high current driver for indicating a voltage direction.

21. A circuit as described in claim 18 wherein said first and second voltages are obtained from digital column gray scale data.

22. A circuit as described in claim 18 said enabler circuit comprises a digital counter.
